(19) United States
(12) Patent Application Publication
(10) Pub. No.: US 2008/0281017 A1
(43) Pub. Date: Nov. 13, 2008

(54) Use of Biocide-Containing, Water-Redispersible Polymer Powder Compositions in Mineral Construction Materials

(75) Inventors: Hans Peter Weitzel, Reischach (DE); Franz Jodlbauer, Marktl (DE)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO., Burghausen (DE)

(21) Appl. No.: 10/596,266

(22) PCT Filed: Dec. 9, 2004
(86) PCT No.: PCT/EP2004/014044

§ 371 Date: Jun. 7, 2006

(30) Foreign Application Priority Data
Dec. 18, 2003 (DE) 103 59 703.4

(51) Int. Cl. C04B 103/67

(52) U.S. Cl. 523/122

(57) ABSTRACT

Mineral construction materials such as mortars and tile adhesives are rendered more resistant to microbial growth by adding biocide in the form of a biocide-containing redispersible polymer powder rather than adding biocide separately.

The invention relates to the use of biocide-containing, water-redispersible polymer powder compositions in mineral building compositions.

Mineral building compositions, for example lime- or cement-bonded building materials such as plasters and renders, knifing fillers and building adhesives need to be protected against weathering influences and microbiological attack by microorganisms, fungi and algae. Particularly under moist weathering conditions, exterior walls are regularly damaged after a few years by growth of algae and fungi if they are not protected by means of appropriate measures. This is alleviated in practice by use of fungicides and/or algicides which are added in high active compound concentrations to the building materials in the dry mortar works or on the building site (film preservation). A disadvantage of this is that these active compounds are quickly degraded under the strongly basic conditions prevailing in the liquid building compositions, and for this reason appropriately large amounts have to be used or the effectiveness decreases considerably over the course of time.

In the use of polymer dispersions, pot preservation has long been prior art in order to protect the aqueous product against microbiological attack. For this purpose, use is made first and foremost of biocidally active compounds.

Water-redispersible powders based on homopolymers or copolymers of ethylenically unsaturated monomers are used as binders in the building sector, for example in combination with hydraulically setting binders such as cement. These serve, for example, to improve the mechanical strength and the adhesion in building adhesives, plasters and renders, mortars and paints. Microbiogically active additives have hitherto not been employed in the preparation and use of redispersion powders, since these systems are not prone to attack in the dry state. These redispersion powders corresponding to the prior art therefore make no contribution to the protection of coatings on the outside of buildings against microbiological attack and attack by algae and fungi.

EP-A 862856 discloses the use of crop protection agents such as pesticides in combination with a redispersible polymer powder for retarded liberation of the active components. WO-A 00/05275 describes redispersible polymer powders as inert carrier substances for active components, for example for crop protection agents and medicaments. WP10105 discloses coating compositions containing fungicides as complexes with cyclodextrin.

It is therefore an object of the invention to provide a redispersible dispersion powder for building compositions, which when used for treating exterior coatings also proves to be effective against attack by microorganisms, algae and fungi.

The invention provides for the use of biocide-containing, water-redispersible polymer powder compositions in mineral building compositions, with the water-redispersible polymer powder compositions based on a film-forming polymer containing from 0.001 to 0.5% by weight of a biocidally active additive.

For the purposes of the present invention, biocides or biocidally active additives are bactericides, fungicides and algicides.

Suitable biocides are commercially available. Active compounds from the class of isothiazolinone and benzimidazole preservatives are usually used against attack by bacteria, yeasts, fungi and algae. Examples are N-octylisothiazolinone, dichloro-N-octylisothiazolinone, chloromethylisothiazolinone, methylisothiazolinone, benzisothiazolinone. Further suitable biocides are benzimidazole derivatives, e.g. 2-(methoxycarbonylamino)benzimidazole, 2,4-diamino-6-methylthio-1,3,5-triazine derivatives, o-phenylphenol, substituted ureas and phenylureas, phthalimide derivatives, e.g. N-(trichloromethylthio)phthalimide, iodocarbamate, pyrethroids, chloroacetamide, sodium borate, methylisopropylphenol, barium metaborate, dithiocarbaminates.

The active compound content is set as a function of the effectiveness and the objective to be achieved. In general, a content of from 0.001 to 0.5% by weight, preferably from 0.001 to 0.2% by weight, particularly preferably from 0.001 to 0.1% by weight, in each case based on the total weight of the water-redispersible polymer powder composition, is employed.

Suitable film-forming polymers are polymers based on one or more monomers from the group consisting of vinyl esters, (meth)acrylic esters, vinylaromatics, olefins, 1,3-dienes and vinyl halides and, if appropriate, further monomers which are copolymerizable therewith.

Suitable vinyl esters are vinyl esters of carboxylic acids having from 1 to 12 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having from 9 to 11 carbon atoms, for example VeoVa9^{R} or VeoVa10^{R} (trade names of Shell). Vinyl acetate is particularly preferred.

Suitable monomers from the group consisting of acrylic esters and methacrylic esters are esters of unbranched or branched alcohols having from 1 to 15 carbon atoms. Preferred methacrylic esters and acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate. Particular preference is given to methyl acrylate, methyl methacrylate, n-butyl acrylate, t-butyl acrylate and 2-ethylhexyl acrylate.

Preferred vinyl aromatics are styrene, methylstyrene and vinyltoluene. A preferred vinyl halide is vinyl chloride. Preferred olefins are ethylene, propylene and preferred dienes are 1,3-butadiene and isoprene.

If desired, from 0.1 to 5% by weight, based on the total weight of the monomer mixture, of auxiliary monomers can be copolymerized. Preference is given to using from 0.5 to 2.5% by weight of auxiliary monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and nitriles, preferably acrylamide and acrylonitrile; monoesters and diesters of fumaric acid and maleic acid, e.g. the diethyl and diisopropyl esters and maleic anhydride, ethylenically unsaturated sulfonic acids or their salts, preferably vinylsulfonic acid, 2-acrylamido-2-methylpropanesulfonic acid. Further examples are precrosslinking comonomers such as multiply ethylenically unsaturated comonomers, for example divinyl adipate, diallyl maleate, allyl methacrylate or triallyl cyanurate, or postcrosslinking comonomers, for example acrylamidoglycolic acid (AGA), methyl methylacrylamidoglycolate (MMAG), N-methylolyacrylamide (NMA), N-methylolmethacrylamide, N-methylolallylcarbamate, alkyl ethers such as isobutoxy ether or esters of N-methylolacrylamide, of N-methylolmethacrylamide and of N-methylolallyl-carbamate. Also suitable are epoxy-functional comonomers such as glycidyl methacrylate and glycidyl acrylate. Further examples are comonomers having a silyl function, e.g. acryloxypropyltri(alkoxy)silanes and methacryloxy-propyltri(alkoxy)silanes, vinyltrialkoxysilanes and vinylmethyldialkoxysilanes, in which, for example, ethoxy radicals and ethoxypropylene glycol ether radicals can be present as alkoxy groups. Mention may also be made of monomers containing hydroxy or CO groups, for example hydroxyalkyl methacrylates and acrylates, e.g. hydroxyethyl, hydroxypropyl or hydroxybutyl acrylate or methacrylate, and also compounds such as diacetoneacrylamide and acetylacetoxyethyl acrylate or methacrylate.

The choice of monomer or the choice of the proportion by weight of the comonomers is made so that, in general, a glass transition temperature Tg of ≦40° C., preferably from −10° C. to +25° C., results. The glass transition temperature Tg of the polymers can be determined in a known manner by means of differential scanning calorimetry (DSC). The Tg can also be calculated approximately beforehand by means of the Fox equation. According to Fox T. G., Bull. Am. Physics Soc. 1, 3, page 123 (1956): 1/Tg=x₁/Tg₁+x₂/Tg₂+ . . . +xₙ/Tgₙ, where xₙ is the mass fraction (% by weight/100) of the monomer n and Tgₙ is the glass transition temperature in kelvin of the homopolymer of the monomer n. Tg values for homopolymers are listed in the Polymer Handbook 2nd Edition, J. Wiley & Sons, New York (1975).

Preference is given to homopolymers or copolymers comprising one or more monomers from the group consisting of vinyl acetate, vinyl esters of α-branched monocarboxylic acids having from 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene. Particular preference is given to copolymers comprising vinyl acetate and ethylene; comprising vinyl acetate, ethylene and a vinyl ester of α-branched monocarboxylic acids having from 9 to 11 carbon atoms; comprising n-butyl acrylate and 2-ethylhexyl acrylate and/or methyl methacrylate; comprising styrene and one or more monomers from the group consisting of methyl acrylate, ethyl acrylate, propyl acrylate, n-butyl acrylate, 2-ethylhexyl acrylate; comprising vinyl acetate and one or more monomers from the group consisting of methyl acrylate, ethyl acrylate, propyl acrylate, n-butyl acrylate, 2-ethylhexyl acrylate and optionally ethylene; comprising 1,3-butadiene and styrene and/or methyl methacrylate and optionally further acrylic esters; with the mixed suspension being able, if desired, to contain one or more of the abovementioned auxiliary monomers.

The greatest preference is given to polymers of the abovementioned compositions which contain from 0.1 to 5% by weight, based on the total weight of the polymer, of monomer units derived from one or more comonomers from the group consisting of ethylenically unsaturated monocarboxylic and dicarboxylic acids, e.g. acrylic acid, methacrylic acid, fumaric acid and maleic acid; ethylenically unsaturated carboxamides and nitriles such as acrylamide and acrylonitrile; monoesters of fumaric acid and maleic acid and also maleic anhydride, ethylenically unsaturated sulfonic acids and their salts, preferably vinylsulfonic acid, 2-acrylamido-2-methylpropanesulfonic acid.

The film-forming polymers are prepared by the emulsion polymerization process or by the suspension polymerization process in the presence of protective colloids and/or emulsifiers, preferably by the emulsion polymerization process, with the polymerization temperature generally being from 40° C. to 100° C., preferably from 60° C. to 90° C., and with the polymerization also being able to be carried out under superatmospheric pressure, in general at a pressure of from 5 bar to 100 bar, in the case of copolymerization of gaseous comonomers such as ethylene. Initiation of the polymerization is carried out using the water-soluble or monomer-soluble initiators or redox initiator combinations customary for emulsion polymerization or suspension polymerization, as the case may be. Examples of water-soluble initiators are sodium persulfate, hydrogen peroxide, azobisisobutyronitrile. Examples of monomer-soluble initiators are dicetyl peroxydicarbonate, dicylcohexyl peroxydicarbonate, dibenzoyl peroxide. The initiators mentioned are generally used in an amount of from 0.01 to 0.5% by weight, based on the total weight of the monomers. Redox initiators used are combinations of the above-mentioned initiators in combination with reducing agents. Suitable reducing agents are, for example, sodium sulfite, sodium hydroxymethanesulfinate and ascorbic acid. The amount of reducing agent is preferably from 0.01 to 0.5% by weight, based on the total weight of the monomers.

To control the molecular weight, regulating substances can be used during the polymerization. If regulators are used, they are usually used in amounts of from 0.01 to 5.0% by weight, based on the monomers to be polymerized, and are introduced separately or else as a premix with reaction components. Examples of such substances are n-dodecyl mercaptan, tert-dodecyl mercaptan, mercaptopropionic acid, methyl mercaptopropionate, isopropanol and acetaldehyde. Preference is given to using no regulating substances.

Suitable protective colloids are partially hydrolysed or fully hydrolysed polyvinyl alcohols; polyvinylpyrrolidones; polyvinyl acetals; polysaccharides in water-soluble form, e.g. starches (amylose and amylopectin), celluloses and their carboxymethyl, methyl, hydroxyethyl, hydroxypropyl derivatives; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and their water-soluble copolymers; melamineformaldehydesulfonates, naphthalene-formaldehydesulfonates, styrene-maleic acid and vinyl ether-maleic acid copolymers. Preference is given to partially hydrolysed or fully hydrolysed polyvinyl alcohols. Particular preference is given to partially hydrolysed polyvinyl alcohols having a degree of hydrolysis of from 80 to 95 mol % and a Höppler viscosity in 4% strength aqueous solution of from 1 to 30 mPas (Höppler method at 20° C., DIN 53015).

Suitable emulsifiers which can be used in an amount of from 0.5 to 10% by weight based on the amount of monomers can be either anionic, cationic or nonionic emulsifiers, for example anionic surfactants such as alkyl sulfates having a chain length of from 8 to 18 carbon atoms, alkyl ether sulfates or alkylaryl ether sulphates having from 8 to 18 carbon atoms in the hydrophobic radical and up to 40 ethylene oxide or propylene oxide units, alkylsulfonates or alkylarylsulfonates having from 8 to 18 carbon atoms, esters and monoesters of sulfosuccinic acid with monohydric alcohols or alkylphenols, or nonionic surfactants such as alkyl polyglycol ethers or alkylaryl polyglycol ethers having from 8 to 40 ethylene oxide units.

After the polymerization is complete, an after-polymerization can be carried out by means of known methods, for example by after-polymerization initiated by means of a redox catalyst, to remove residual monomers. Volatile residual monomers can also be removed by means of distillation, preferably under reduced pressure, and, if desired, with inert stripping gases such as air, nitrogen or steam being passed through or over the liquid. The aqueous dispersions which can be obtained in this way have a solids content of from 30 to 75% by weight, preferably from 50 to 60% by weight.

To prepare the biocide-containing, water-redispersible polymer powder compositions, the biocides are mixed in the amount indicated into the aqueous dispersions, and the dispersions are, if appropriate after addition of protective colloids as atomizing aids, dried, for example by means of fluidized-bed drying, freeze drying or spray drying. The dispersions are preferably spray dried. Spray drying is carried out in customary spray drying units, with atomization being able to be effected by means of single-fluid, two-fluid or multifluid nozzles or by means of a rotating disk. The outlet temperature is generally in the range from 45° C. to 120° C., preferably from 60° C. to 90° C., depending on the unit, the Tg of the resin and the desired degree of drying.

In general, the atomization aid is used in a total amount of from 3 to 30% by weight, based on the polymeric constituents of the dispersion, i.e. the total amount of protective colloid prior to the drying procedure should be at least from 3 to 30% by weight, based on the proportion of polymer. Preference is given to using from 5 to 20% by weight, based on the proportion of polymer.

Suitable atomization aids are, for example, the protective colloids which have been mentioned above. Preference is given to using no further protective colloids other than polyvinyl alcohols as atomization aid.

A content of up to 1.5% by weight of antifoam, based on the base polymer, has frequently been found to be advantageous for atomization. To increase the storage stability by improving the blocking resistance, particularly in the case of powders having a low glass transition temperature, the powder obtained can be treated with an antiblocking agent (anticaking agent), preferably in an amount of up to 30% by weight, based on the total weight of polymeric constituents. Examples of antiblocking agents are Ca carbonate or Mg carbonate, talc, gypsum, silica, kaolins, silicates having particle sizes which are preferably in the range from 10 nm to 10 μm.

To make the powders hydrophobic, one or more hydrophobicizing agents from the group consisting of fatty acids and fatty acid derivatives and organosilicon compounds can be added to the dispersions prior to drying. Compounds which are suitable for this purpose are listed, for example, in DE-A 10323205.

The viscosity of the feed to be atomized is set via the solids content so that a value of <500 mPas (Brookfield viscosity at 20 revolutions per minute and 23° C.), preferably <250 mPas, is obtained. The solids content of the dispersion to be atomized is >35%, preferably >40%.

As an alternative, the biocides can, if they are present in solid form, be subsequently mixed as powder into the dried polymer dispersion.

These biocide-containing dispersion powders can be used in a variety of mineral building compositions, for example in conjunction with hydraulically setting binders such as cements (portland, alumina, trass, slag, magnesia, phosphate cement) or water glass, or in gypsum-containing compositions, in lime-containing compositions or cement-free compositions and compositions bound by means of polymers. They are preferably used for the production of building adhesives, in particular tile adhesives and thermal insulation adhesives, and also in plasters and renders, knifing fillers, flooring screeds, leveling compositions, sealing slurries, jointing mortars and paints, and also for sealing membranes in tunnel construction and underground works.

These redispersion powders are particularly advantageously used in the treatment of coatings in the exterior sector, which can in this way be protected against microbiological attack using significantly lower active compound contents than those employed hitherto. The results obtained indicated that the amount of biocide used can be reduced by a factor of 10 or more, with corresponding economic, ecological and occupational safety advantages.

The following examples illustrate the invention:

### EXAMPLE 1

A polyvinyl alcohol-stabilized dispersion of a copolymer of vinyl acetate, vinyl versatate (Veova10) and ethylene having a glass transition temperature of 5° C. is admixed with 10 parts (solid/solid) of a polyvinyl alcohol having a degree of hydrolysis of 88 mol % and a Höppler viscosity of 4 mPas and adjusted to a solids content of 35%. N-Octylisothiazolinone (in the form of Acticide OTW) is added to this dispersion in an amount corresponding to an active compound content of 750 ppm based on powder and the dispersion is spray dried.

### EXAMPLE 2

A polyvinyl alcohol-stabilized dispersion of a copolymer of vinyl acetate, vinyl versatate (Veova10) and ethylene having a glass transition temperature of 5° C. is admixed with 10 parts (solid/solid) of a polyvinyl alcohol having a degree of hydrolysis of 88 mol % and a Höppler viscosity of 4 mPas and adjusted to a solids content of 35%. N-Octylisothiazolinone (in the form of Parmetol DF18) is added to this dispersion in an amount corresponding to an active compound content of 350 ppm based on powder and the dispersion is spray dried.

### COMPARATIVE EXAMPLE 3

The procedure of Examples 1 and 2 was repeated, but without addition of biocide.

### Use Test:

A render was formulated as indicated in Table 1 using the dispersion powders from Examples 1 and 2 and Comparative Example 3 and applied to an exterior wall.

TABLE 1

| | | |
|---|---|---|
| 70.0 | parts by weight | Dyckerhoff white cement |
| 456.3 | parts by weight | chalk (calcite 500) |
| 282.5 | parts by weight | chalk (calcite 0.5-1.0) |
| 67.5 | parts by weight | slagged lime |
| 70.0 | parts by weight | chalk (Omya BL) |
| 14.5 | parts by weight | titanium dioxide (Kronis 2959) |
| 4.4 | parts by weight | fiber (Arbocel BC 1000) |
| 1.7 | parts by weight | mineral thickener (Lanco Thix |
| | | P12) |
| 1.6 | parts by weight | methylcellulose (Tyolose NH 10001 |
| | | P4) |
| 30.0 | parts by weight | dispersion powder |
| 25.0 | parts by weight | water per 100 parts by weight of |
| | | dry mix |

### COMPARATIVE EXAMPLE 4

The biocide-free powder from Comparative Example 3 was used in the formulation and 225 ppm of N-octylisothiazolinone (Acticide OTW) was added to the render formulation via the make-up water.

### Testing of Growth on the Exterior Wall:

Polystyrene foam boards which had been provided with a cement-containing reinforcing mortar were coated with the render formulations which had been modified in the manner indicated using powders from Examples 1 and 2 and from Comparative Examples 3 and 4 and were weathered in the open for 11 months. The amount of growth formed on the boards was monitored at regular intervals and evaluated qualitatively according to the following scale: 0=no growth, +=small amount of growth, ++=moderate amount of growth, +++=large amount of growth. The results are summarized in Table 2.

TABLE 2

| Example | 3 months | 6 months | 9 months | 12 months |
|---|---|---|---|---|
| Example 1 | 0 | 0 | 0 | 0 |
| Example 2 | 0 | 0 | 0 | 0 |
| Comp. Ex. 3 | 0 | + | ++ | +++ |
| Comp. Ex. 4 | 0 | 0 | + | + |

The examples demonstrate the excellent effectiveness of the treatment according to the invention. Unprotected systems (Comparative Example 3) display a large amount of growth relatively early. The growth cannot be completely suppressed even by direct addition of large amounts of active compound (Comparative Example 4). The examples according to the invention, on the other hand, show that reliable protection is ensured despite a considerably lower active compound concentration (Ex. 1=22.5 ppm, Ex. 2=10.5 ppm, Ex. 4=225 ppm of biocide, in each case based on the formulation).

1-10. (canceled)

11. In a curable mineral construction product containing a film forming redispersible polymer powder, the improvement comprising:
employing as said redispersible polymer powder, a redispersible polymer powder composition comprising at least one film forming redispersible polymer powder, and at least one biocide.

12. The construction product of claim 11, wherein said redispersible polymer powder composition is prepared by spray drying an aqueous redispersible polymer dispersion and at least one biocide.

13. The construction product of claim 12, wherein biocide is added to said aqueous redispersible polymer dispersion prior to spray drying.

14. The construction product of claim 11 which contains a hydraulically setting mineral binder.

15. The construction product of claim 11, wherein at least one hydraulically setting binder is selected from the group consisting of cement, water glass, gypsum, and lime.

16. The construction product of claim 11, wherein at least one film forming polymer comprises a polymer polymerized from one or more monomers selected from the group consisting of vinyl esters, (meth)acrylic esters, vinylaromatics, olefins, 1,3-dienes, vinyl halides, and optionally, further monomers copolymerizable therewith.

17. The construction product of claim 11, wherein at least one film forming polymer comprises a copolymer comprising vinyl acetate and ethylene, a copolymer comprising vinyl acetate, ethylene and a vinyl ester of α-branched monocarboxylic acids having from 9 to 11 carbon atoms, or a copolymer comprising styrene and one or more of methyl acrylate, ethyl acrylate, propyl acrylate, n-butyl acrylate, or 2-ethylhexyl acrylate.

18. A process for increasing the resistance of cured mineral building products containing a biocide to microbial growth, comprising adding at least one biocide in the form of a dry composition containing at least one film forming redispersible polymer powder and at least one biocide.

19. A process for the preparation of a curable, biocide-containing mineral building material of claim 11, comprising admixing
a) one or more mineral building composition components;
b) water; and
c) a redispersible polymer powder composition comprising at least one film forming redispersible polymer powder and a biocidal additive of at least one biocide, said biocidal component present in an amount of from 0.001 to 0.5 weight percent based on the weight of the redispersible polymer powder composition.

20. The process of claim 19, wherein at least one biocide is a fungicide.

21. The process of claim 19, wherein an isothiazolinone, benzisothiazolinone or mixture thereof is used as a biocide.

22. The process of claim 21, wherein at least one biocide is N-octylisothiazolinone.

23. The process of claim 19, wherein the biocide(s) are present in a total amount of from 0.001 to 0.1% by weight, based on the weight of the water-redispersible polymer powder composition.

24. The process of claim 19, wherein at least one film forming polymer is a polymer polymerized from one or more monomers selected from the group consisting of vinyl esters, (meth)acrylic esters, vinylaromatics, olefins, 1,3-dienes, vinyl halides, and optionally, polymerized further monomers copolymerizable therewith.

25. The process of claim 24, wherein said film forming polymer comprises a copolymer comprising vinyl acetate and ethylene, a copolymer comprising vinyl acetate, ethylene and a vinyl ester of α-branched monocarboxylic acids having from 9 to 11 carbon atoms, or a copolymer comprising styrene and one or more of methyl acrylate, ethyl acrylate, propyl acrylate, n-butyl acrylate, or 2-ethylhexyl acrylate.

26. The process of claim 19, wherein the water-redispersible polymer powder composition is obtained by mixing the biocide into the aqueous polymer dispersions prior to drying or adding it after drying.

27. The process of claim 19, wherein said mineral building composition component comprises one or more hydraulically setting binders selected from the group consisting of cement, water glass, gypsum, and lime.

28. The process of claim 27, wherein said curable biocide mineral building material is a building adhesive selected from the group consisting of tile adhesives, thermal insulation adhesives, plasters, renders, knifing fillers, flooring screeds, leveling compositions, sealing slurries, jointing mortars, paints, and sealing grouts for tunnel construction and underground works.

29. The process of claim 19, wherein the mineral building composition components contain no hydraulically setting binders.
